(19) United States
(12) Patent Application Publication
(10) Pub. No.: US 2022/0377854 A1
(43) Pub. Date: Nov. 24, 2022

(54) Electric Heating Apparatus

(71) Applicant: Eberspãcher catem GmbH & Co.KG, Herxheim (DE)

(72) Inventors: Ahmad Asafi, Karlsruhe (DE); Michael Niederer, Kapellen-Drusweiler (DE)

(21) Appl. No.: 17/748,574

(22) Filed: May 19, 2022

(30) Foreign Application Priority Data
May 20, 2021 (DE) 10 2021 113 148.0

(51) Int. Cl. H05B 3/50; B60H 1/22

(52) U.S. Cl. CPC H05B 3/50; B60H 1/2225; H05B 2203/02

(57) ABSTRACT

An electric heating apparatus includes a PTC heating device comprising at least one PTC element and electric conductor tracks which are connected to the PTC element in an electrically conductive manner, and a housing which receives the PTC heating device and on which inlet and outlet openings for a fluid to be heated are exposed. A helically-shaped tube is provided in the housing and connects the inlet opening to the outlet opening and is coupled to the PTC heating device in a thermally conductive manner.

### BACKGROUND OF THE INVENTION

### 1. Field of the Invention

The present invention relates to an electric heating apparatus with an electric heating device. The electric heating device may be a PTC heating device comprising at least one PTC element and electric conductor tracks which are connected to the PTC element in an electrically conductively manner. The electric heating apparatus further has a housing that receives the heating device. Inlet and outlet openings for a fluid to be heated are exposed on the housing.

### 2. Background of the Invention

Such an electric heating apparatus with PTC heating devices is known, for example, from EP 1 872 986 A1.

The previously known electric heating apparatus is a fluid heater which separates a heating chamber, which communicates with the inlet and outlet openings, by way of a partition wall from a connection chamber in which the electrical connection of the PTC heating devices is established. The PTC heating devices are received in elongate tubes that are open toward the connection chamber and closed toward the heating chamber. The tubes must be fluid-tight in order to prevent the medium to be heated from reaching the PTC heating device, in particular the current-carrying components there. The tubes must also be connected to the partition wall in a fluid-tight manner in order to prevent the fluid from escaping into the connection chamber. A control apparatus for controlling the power current is typically also disposed in the connection chamber.

In high-voltage applications in particular, in which the PTC elements are operated at a high voltage of up to 600 to 800 amperes, careful sealing and electrical insulation between the fluid to be heated and the current-carrying parts of the PTC heating devices must be ensured. These measures to be taken in prior art make the structure complex. The measures also increase the heat path between the PTC elements and the fluid to be heated so that the efficiency of the PTC heating apparatus tends to deteriorate.

### SUMMARY

The present invention is based on the object of specifying a heating device of the type mentioned at the outset which satisfies the safety requirements in an improved manner. The present invention intends in particular to specify an electric heating apparatus for installation in a motor vehicle. Vibration-resistant properties and an otherwise robust design of the electric heating apparatus are presently particularly important for it to remain continuously operational even under the harsh conditions of motor vehicle operation.

According to the present invention, a helically shaped tube connecting the inlet opening to the outlet opening is provided in the housing. This tube is connected in a thermally conductive manner to the at least one heating device.

Like in prior art, the housing is used to mount the electric heating apparatus, in particular to the motor vehicle. The housing need not necessarily be self-contained. However, such a structure is beneficial with regard to the electrical safety of the component. The housing can be made of plastic material or metal. With regard to EMC safety, the housing may be formed from metal. The housing should at least be configured such that the electrically conductive parts provided inside the housing are supported in the housing in an insulating manner and/or are surrounded by a metallic envelopment so that electromagnetic interference does not reach the exterior.

In a manner known per se, inlet and outlet openings are exposed on the exterior of the housing. They can be formed by tube sockets that are suitable for connecting a hose or a line that carry the medium to be heated. These openings are in communication with the helically shaped tube within the housing. The tube can be configured in the manner of a helix having a uniform internal and external diameter. In such a helix, the individual turns are spaced axially from one another. However, such a strictly geometric configuration is not of relevance in the present case. The turns can basically be formed in any basic shape. The basic shape is understood to be that base area of the helically shaped tube which arises in a top view onto the helically shaped tube in the axial direction, i.e. in the direction of the pitch of the individual turns. With regard to a space-saving structure of the electric heating apparatus as a whole, this basic shape can be circular, oval, or also generally rectangular.

If the helically shaped tube is produced by bending, it goes without saying that the basic shape is characterized by round corners. However, the helically shaped tube can also be composed of segments formed from a tubular semi-finished product by technologies other than forming. These individual segments can be placed together in a fluid-tight manner. With regard to simple mass production and scaling, the individual segments should each correspond to one turn, i.e. have an angle of envelopment of 360° of the respective helical configuration.

The electric heating apparatus comprises a resistance heating element. In the case of a PTC heating device, this resistance heating element is a PTC element. The resistance heating element of the electric heating apparatus can be any electrically operated heating element.

The electric heating apparatus according to the invention can be used as heating in the field of building technology, e.g. for heating houses or buildings, respectively. The electric heating apparatus according to the invention can also be used in means of transport that are operated in the air, on water, or on land. In this case, it is desirable to configure the resistance heating element as a PTC heating element.

At least one resistance heating element may be provided between adjacent turns of the tube and is coupled to them in a thermally conductive manner. In this configuration, the at least one resistance heating element is disposed in the axial direction between adjacent turns of the tube. The respective PTC element typically covers a considerable circumferential section of the helically shaped tube. In a helically shaped tube with a circular ring or base area, the circumferential section is at least 20° for every heating device.

Electrical insulation may be provided between an inner circumferential surface of the tube and the resistance heating element provided opposite thereto on the outer circumference, for example, in the form of a PTC element. This electrical insulation can be provided by the nature of the material of the tube or a coating for it. The inner circumferential surface defines the flow passage through the tube. In the case of a metallic tube, which is useful for reasons of thermal conductivity, the outer circumferential surface can be provided with an electrically insulating coating, for example, a ceramic coating or a plastic coating. Alternatively or additionally, electrical insulation can be provided on the side of the heating device between the resistance heating element and/or the electric conductor track. Such electrical insulation can be in the form of a Kapton film. Other configurations are also conceivable. A ceramic layer can be provided as an insulating layer on the outer side of the resistance heating element and/or the conductor track provided for this purpose.

It goes without saying that the resistance heating element is abutted with its main side surfaces at least indirectly against the oppositely disposed turns of the tube. In this case, the main side surfaces are those oppositely disposed surfaces of the PTC element, which is configured, for example, in the shape of a cuboid, that have the greatest areal extension of all surfaces of the resistance heating element.

The basic shape of the resistance heating element, for example the PTC element, can be adapted to the shape of the tube. In the case of a circular basic shape, the PTC element can also be in the shape of a sector of a circle or a ring sector so that the main side surfaces of the PTC element are substantially covered entirely by the adjacent turns of the tube and abut thereagainst in a thermally conductive manner.

According to a possible further development of the present invention, a carrier is provided from which several resistance heating elements/PTC elements project, each of which is provided between adjacent turns of the tube. They are typically PTC heating devices which are spaced from one another with an axial spacing of the helical configuration relative to each other. In other words, the individual heating devices carried by the common carrier are disposed one above the other in the axial direction of the helically shaped tube, while the carrier extends axially. With regard to the simplest possible assembly, the carrier may be disposed on the outer circumference relative to the helically shaped tube. The individual resistance heating elements/PTC elements project radially inwardly and between the turns of the helically shaped tube, where they abut against the tube in a thermally conductive manner.

In order to increase the heat output, several of such carriers can be provided distributed in the circumferential direction of the helically shaped tube. Heat is then coupled into the tube at various points around the circumference.

The carrier may have has a conductor assembly. The carrier typically accommodates this conductor assembly. The carrier can bring about electrically insulated and possibly encapsulated accommodation of the conductor assembly. This conductor assembly may be formed by a printed circuit board which is plug connected to the individual heating elements. The printed circuit board can also be formed by busbars which are punched out and supported in the carrier in an electrically insulating manner and form plug contacts for electrically contacting the at least one heating device. Each of the conductor tracks is there typically formed from a sheet metal strip, where each of the sheet metal strips may form a contact strip which can be plug contacted in the conductor assembly, cf. DE 20 2019 005 222 U1.

The heating devices supported by a carrier can be associated with a single heating circuit. In this configuration, several heating circuits that can be switched from one another can be formed by carriers and their heating devices that are respectively spaced in the circumferential direction.

As mentioned, the carriers typically extend in the axial direction of the helically shaped tube. The carriers can be connected to a control device above or below the tube.

According to a possible further development of the present invention, the electric heating apparatus has a respective control device for controlling the heat output of the electric heating apparatus, where this control device is connected at least electrically to the at least one conductor assembly.

The control device may have at least one power switch that generates waste heat and is connected to the tube in a thermally conductive manner. As a result, the thermal dissipation loss of the control device can be used to heat the fluid conveyed in the tubes.

With regard to good heat extraction, the at least one heating device is provided subject to a pretension between adjacent turns of the tube. Such pretension can be brought about by an external spring which is supported on the housing and acts upon the turns in the axial direction. However, such pretension can also be brought about by the turns being produced in the manner of a helical spring at a distance from one another which is less than the axial height of the heating device so that the helically shaped tube needs to be resiliently stretched axially for the heating device to be inserted between adjacent turns. As a result, the respective heating device then abuts against oppositely disposed walls of the tube subject to a pretension created by the tube itself. The tube may be a flat tube.

### BRIEF DESCRIPTION OF THE DRAWINGS

Further details and advantages of the present invention shall become apparent from the following description of an embodiment in combination with the drawing, in which:

FIG. 1 shows a schematic external view of an embodiment of an electric heating apparatus;

FIG. 2 shows a side view of essential details of the electric heating apparatus according to FIG. 1;

FIG. 3 shows a sectional side view of detail D of FIG. 2; and

FIG. 4 shows an enlarged perspective view of the detail of FIG. 2.

### DETAILED DESCRIPTION

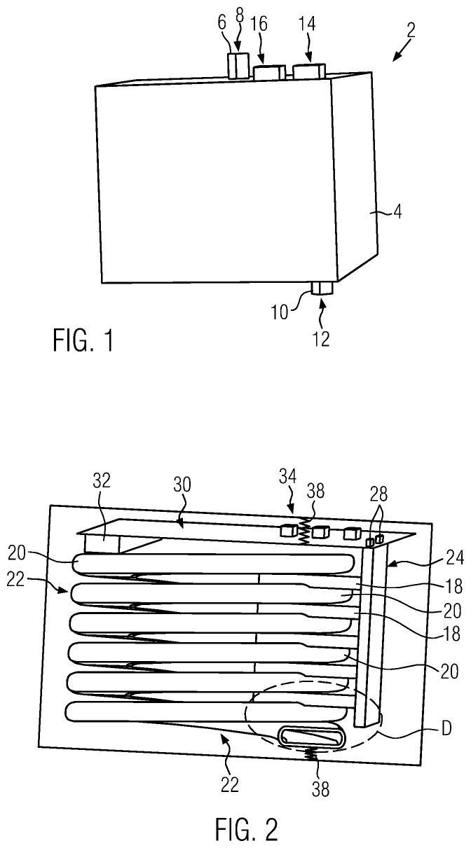

FIG. 1 shows an electric heating apparatus denoted with reference character 2 which comprises a housing 4, which on its upper side has a tube socket 6 projecting thereover which defines an inlet opening 8 and on its underside by a tube socket 10 which forms an outlet opening 12. Two connectors can be seen on the upper side, of which the connector denoted with reference character 14 is the power current connecter. The power current for the operation of the PTC heating devices is supplied via this power current connector 14. The component denoted with reference character 16 forms the control current connector.

The side view of FIG. 2, in which the housing is sectioned, illustrates PTC heating devices having reference character 18 that are provided between turns 20 of a helically shaped tube denoted with reference character 22. As illustrated in FIG. 4, the helically shaped tube 22 is formed with a ring-shaped base. The helically shaped tube 22 is configured as a helix with a uniform interior diameter and a uniform exterior diameter. The various turns 20 extend in the axial direction X of the helically shaped tube 22.

In the exemplary embodiment shown in FIGS. 2 to 4, a single carrier 24 from which the multiple PTC heating devices 18 project is illustrated so that the PTC heating devices 18 are spaced from one another in the axial direction X and are provided between the individual turns 20. The carrier 24 mechanically supports the individual PTC heating devices 18. Disposed inside the carrier 24 is a conductor assembly 26 by way of which the individual PTC heating devices 18 are electrically connected. This conductor assembly 26 has contact strips 28 projecting over the carrier 24 on the upper side which are electrically plug connected in a printed circuit board 30 populated with electronic components. The printed circuit board 30 also carries a power switch 32 which abuts against the uppermost turn 20 of the tube 22. A control device denoted with reference numeral 34 is formed by the populated printed circuit board 30 including the power switch 32. This control device 34 switches the power current and receives control signals via the control current connector 16. The thermal dissipation loss of the power switch 32 is transferred directly to the tube 22 by thermal conduction. Electrical insulation, for example, in the form of a Kapton film, can be provided between the power switch 32 and the tube 22.

In the embodiment shown, the tube 22 has a ceramic coating on its main side surfaces to form an electrical insulation 36.

FIG. 2 schematically illustrates a spring 38 by way of which the individual turns 20 are each abutted against one another with the interposition of the PTC heating devices 18 in a pretensioned manner. This ensures good thermally conductive contact between the individual turns 20 of the tube 22 and the PTC heating devices 18.

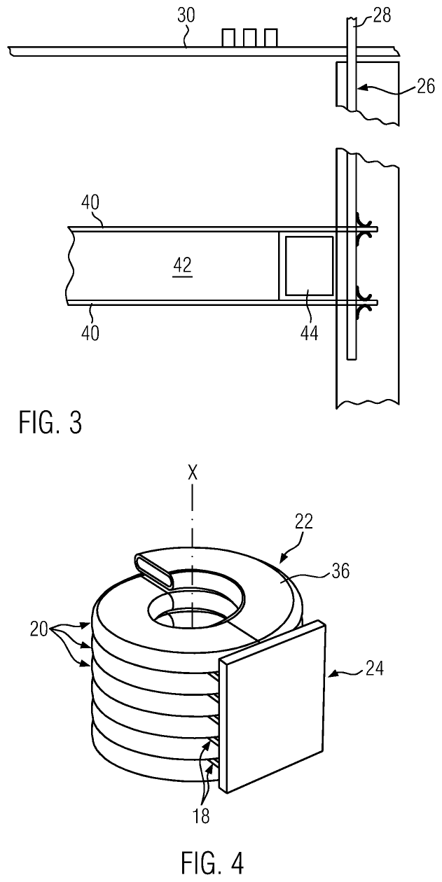

Its internal structure is illustrated in FIG. 3.

A PTC element 42 is provided between electric conductor tracks 40 and abuts against the electric conductor tracks 40 in an electrically conductive manner. For this purpose, the electric conductor tracks 40 can be abutted only against the PTC element 42. In the embodiment shown, this PTC heating cell is surrounded by a plastic frame 44 which is mechanically coupled to the carrier 24 and forms a recess for receiving the at least one PTC element 42. The frame 44 is formed from insulating material. The recess has a lower height than the total height of the PTC element 42 together with the electric conductor tracks 40 so that the electric conductor tracks 40 on the side disposed opposite to the PTC element 42 each abut directly against the electrical insulation 36 of the turns 20.

1. An electric heating apparatus comprising:
a PTC heating device comprising at least one PTC element and electric conductor tracks which are connected to the PTC element in an electrically conductive manner;
a housing which receives the heating device and on which inlet and outlet openings for a fluid to be heated are exposed; and
a helically-shaped tube which is provided in the housing, which connects the inlet opening to the outlet opening, and which is coupled to the heating device in a thermally conductive manner.

2. The electric heating apparatus according to claim 1, wherein the helically-shaped tube has turns formed therein which collectively form a helix.

3. The electric heating apparatus according to claim 2, wherein at least one PTC element is coupled to adjacent turns of the helically-shaped tube in a thermally conductive manner.

4. The electric heating apparatus according to claim 1, wherein an electrical insulation is provided on an inner circumferential surface of the helically-shaped tube, and wherein the PTC element is provided opposite the insulation on an outer circumference of the helically-shaped tube.

5. The electric heating apparatus according to claim 2, further comprising a carrier from which several heating devices project at locations between adjacent turns of the helically-shaped tube.

6. The electric heating apparatus according to claim 5, wherein the carrier carries several heating devices provided one above the other in an axial direction of the helically-shaped tube.

7. The electric heating apparatus according to claim 5, wherein several carriers are provided and are distributed in a circumferential direction of the helically-shaped tube.

8. The electric heating apparatus according to claim 1, wherein the carrier accommodates a conductor assembly which is connected in an electrically conductively manner to the heating devices held by the carrier.

9. The electric heating apparatus according to claim 1, further comprising a control device which controls the heat output of the electric heating apparatus, which is provided within the housing, and which is electrically connected to the conductor assembly.

10. The electric heating apparatus according to claim 9, wherein the control device comprises at least one power switch which generates waste heat and which is connected to the helically-shaped tube in a thermally conductively manner.

11. The electric heating apparatus according to claim 1, wherein the heating device is provided subject to a pretension between adjacent turns of the helically-shaped tube.
